(19) United States
(12) Patent Application Publication
(10) Pub. No.: US 2014/0252729 A1
(43) Pub. Date: Sep. 11, 2014

(54) MULTI-FUNCTION FAST-ASSEMBLY MOUNTING HOLE

(71) Applicant: YANGZHOU SHENGYE MACHINERY CO., LTD., Jiangsu (CN)

(72) Inventor: Hongming Xu, Jiangsu (CN)

(73) Assignee: YANGZHOU SHENGYE MACHINERY CO., LTD., Jiangsu (CN)

(21) Appl. No.: 14/360,854

(22) PCT Filed: Jul. 22, 2013
(86) PCT No.: PCT/CN2013/078810

§ 371 Date: May 27, 2014

(30) Foreign Application Priority Data
Nov. 6, 2012 (CN) 201210437997.8

(51) Int. Cl. B25F 3/00

(52) U.S. Cl. CPC B25F 3/00
USPC 279/143

(57) ABSTRACT

The present invention relates to a multi-function fast-assembly mounting hole. A rectangular top portion of the mounting hole has a half-round hole, first and second position limiting holes symmetrically extend outside on the half-round hole of the top portion of the mounting hole, a plurality of small rectangular positioning holes is uniformly distributed on the edge of the mounting hole, an opening is formed at one end of each of any three rectangular positioning holes, each opening end communicates with the mounting hole through a straight flute, a bottom portion of the mounting hole is a fast-assembly opening, and third and fourth position limiting holes are symmetrically disposed at junctions between two sides of the fast-assembly opening and the mounting hole. The present invention is applicable to 98% of domestic and foreign electric tools, thereby greatly improving the utilization of the electric tools, and also greatly improving the productivity and reducing the work intensity of users because it is convenient and quick for the users to change a tool head.

### BACKGROUND

1. Technical Field

The present invention relates to mounting holes of electric tools, and more particularly to a multi-function fast-assembly mounting hole.

2. Related Art

Nowadays, industrial technologies change very quickly. With the continuous development of the industrial technologies, more and more electric tools emerge, which are used in many fields, such as cutting, polishing, trimming, and drilling. The tool is disposed on a handheld electric tool driven by a motor. At present, different factories use different hole-shaped interfaces, so that many types of supporting tools emerge, which brings much convenience for users to purchase fittings when using the tool. Time of customers is wasted in selection, and also, purchasing is not easy when different product fittings of different factories are used.

### SUMMARY

To solve the foregoing problem, the present invention provides a multi-function fast-assembly mounting hole with a simple structure, convenient assembly, and strong universality.

The technical solution of the present invention is: A rectangular top portion of the mounting hole has a half-round hole, first and second position limiting holes symmetrically extend outside on the half-round hole of the top portion of the mounting hole, a plurality of small rectangular positioning holes is uniformly distributed on the edge of the mounting hole, an opening is formed at one end of each of any three rectangular positioning holes, each opening end communicates with the mounting hole through a straight flute, a bottom portion of the mounting hole is a fast-assembly opening, and third and fourth position limiting holes are symmetrically disposed at junctions between two sides of the fast-assembly opening and the mounting hole.

An angle of the fast-assembly opening is 60°.

The present invention not only is applicable to half-round and round rivets and dedicated hole types for welding and fast assembly, but also has strong universality. The novel design of the product completely changes a conventional mounting method in which fastening is performed by using a bolt. The design can not only be used on a conventional handheld electric tool, but also be applicable to fast-mounting handheld electric tools of many domestic and foreign factories. Our company designs and develops this dedicated hole type for fast mounting according to different hole types of different domestic and foreign electric tools, which greatly improves the utilization of the electric tools, and practically solves a problem that purchasing is difficult for users; meanwhile, saves the purchase fund of the users, reduces the purchase costs, and brings much convenience for the users.

The present invention not only is applicable to an ordinary electric tool, where a bolt is tightly mounted in a tool head, but also is characterized by fast assembly, so that the universality is stronger. The edge of the mounting hole has nine small rectangular positioning holes, the mounting hole is designed to have a rectangular hole with half rounds on a top portion and a fast-assembly opening with an angle of 60° on a bottom portion, and 4 position limiting holes are disposed in the mounting hole. In this way, the tool head is applicable to 98% of domestic and foreign electric tools, thereby greatly improving the utilization of the electric tools, and also greatly improving the productivity and reducing the work intensity of users because it is convenient and quick for the users to change the tool head.

### BRIEF DESCRIPTION OF THE DRAWING

The disclosure will become more fully understood from the detailed description given herein below for illustration only, and thus are not limitative of the disclosure, and wherein:

FIG. 1 is a schematic structural diagram of the present invention.

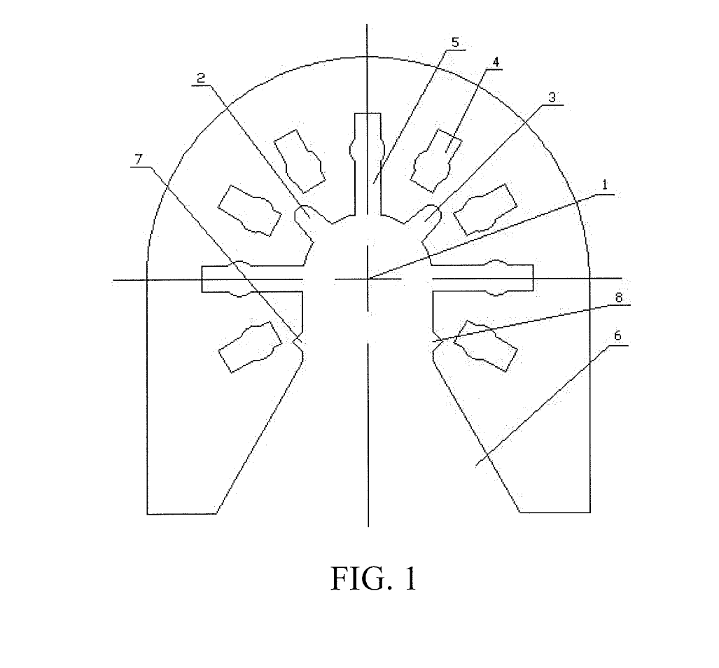

In FIG. 1, 1 is an mounting hole, 2 is a first position limiting hole, 3 is a second position limiting hole, 4 is a positioning hole, 5 is a straight flute, 6 is a fast-assembly opening, 7 is a third position limiting hole, and 8 is a fourth position limiting hole.

### DETAILED DESCRIPTION

A multi-function fast-assembly mounting hole is provided. A rectangular top portion of the mounting hole 1 has a half-round hole, a first position limiting hole 2 and a second position limiting hole 3 symmetrically extend outside on the half-round hole of the top portion of the mounting hole 1, nine small rectangular positioning holes 4 are uniformly distributed on the edge of the mounting hole 1, a transition round hole is disposed in each of the rectangular positioning holes 4, an opening is formed at one end of each of any three rectangular positioning holes 4, each opening end communicates with the mounting hole 1 through a straight flute 5, the remaining six rectangular positioning holes 4 are closed, a bottom portion of the mounting hole 1 is a fast-assembly opening 6, a third position limiting hole 7 and a fourth position limiting hole 8 are symmetrically disposed at junctions between two sides of the fast-assembly opening 6 and the mounting hole 1, and an angle of the fast-assembly opening 6 is 60°.

What is claimed is:

1. A multi-function fast-assembly mounting hole, wherein a rectangular top portion of the mounting hole has a half-round hole, first and second position limiting holes symmetrically extend outside on the half-round hole of the top portion of the mounting hole, a plurality of small rectangular positioning holes is uniformly distributed on the edge of the mounting hole, an opening is formed at one end of each of any three rectangular positioning holes, each opening end communicates with the mounting hole through a straight flute, a bottom portion of the mounting hole is a fast-assembly opening, and third and fourth position limiting holes are symmetrically disposed at junctions between two sides of the fast-assembly opening and the mounting hole.

2. The multi-function fast-assembly mounting hole according to claim 1, wherein an angle of the fast-assembly opening is 60°.
